(19) United States
(12) Patent Application Publication
(10) Pub. No.: US 2008/0088187 A1
(43) Pub. Date: Apr. 17, 2008

(54) Electric Motor with Reduced EMI

(75) Inventors: Liang Shao, Ann Arbor, MI (US); Makato Torigoe, West Bloomfield, MI (US); George Saikalis, West Bloomfield, MI (US)

Correspondence Address: GIFFORD, KRASS, SPRINKLE,ANDERSON & CITKOWSKI, P.C, PO BOX 7021, TROY, MI, 48007-7021, US

(73) Assignee: Hitachi, Ltd, Tokyo (JP)

(21) Appl. No.: 11/550,065

(22) Filed: Oct. 17, 2006

(51) Int. Cl. H02K 5/24; H02K 11/00; H02K 5/16; H02K 13/00

(52) U.S. Cl. 310/51; 310/90; 310/71; 310/219

(57) ABSTRACT

An electric motor particularly suited for a hybrid electric automotive vehicle. The motor includes a stator housing and a rotor having a core and rotatably mounted to the housing by a bearing assembly. An electrical conductor separate from the bearing assembly provides a low impedance electrical conductive path for high frequency radio emissions from the rotor core and to the stator housing thus reducing the transmission of electrical magnetic interference from an output shaft of the rotor.

### BACKGROUND OF THE INVENTION

I. Field of the Invention

The present invention relates generally to electric motors and, more particularly, to an electric motor particularly suited for an electric motor powered automotive vehicle with reduced EMI emissions.

II. Description of Related Art

Many modern automotive vehicles are now hybrid electric vehicles (HEV) which are powered by a gasoline engine during certain operating conditions and an electric motor for other operating conditions. As such, an HEV has many more power electronic components than the previously known gasoline or diesel engine only automotive vehicles.

Many of the components of the electronics for the HEV are powered using pulse width modulation. Furthermore, some of these electronics, and particularly the power supply circuit for the electric motor, must be switched with very high voltages, e.g. 300 volts. Such pulse width modulation of these high voltages disadvantageously generates high frequency radio emissions which cause electromagnetic interference (EMI).

Although it is common to shield the power supply source for the HEV in order to reduce EMI, such shielding is not wholly effective to eliminate the EMI. Instead, significant high frequency radio emissions are coupled by the electromagnetic field to tie motor rotor core during the operation of the electric motor.

The rotor of the electric motor is typically rotatably mounted to the stator housing by a bearing assembly and, conventionally, these bearing assemblies include metal components, such as steel bearings, which inherently electrically connect the rotor to the stator housing. The bearing assembly for the electric motor can exhibit relatively high impedance at high radio frequencies, e.g. 500 kilohertz to 109 megahertz. Such relatively high impedance at high radio frequencies is due to a number of factors including, for example, the lubrication used in the bearing assembly which interferes with the electrical conduction between the rotor and stator housing through the bearing assembly.

In these situations, the voltage potential of rotor output shaft fluctuates due to the existence of the impedance between the rotor shaft and stator housing. Consequently, the high frequency radio emissions travel along the rotor output shaft which acts as an antenna for the transmission of the radio emissions thus causing electromagnetic interference. Such EMI disadvantageously interferes with the radio reception by a radio in the automotive vehicle. Indeed, in extreme cases, the EMI transmitted by the rotor output shaft may cause interference with the other electronic components of the HEV.

### SUMMARY OF THE INVENTION

The present invention provides an electric motor particularly suited for an HEV which overcomes all of the above-mentioned disadvantages of the previously known devices.

In brief, the electric motor of the present invention comprises a stator housing and a rotor having a rotor core rotatably mounted within the stator housing by a bearing assembly. The rotor has an output shaft which is used to rotatably drive the load, such as the wheels in an HEV.

Means separate from the bearing assembly then provide an electrically conductive path at high radio frequencies, e.g. 500 kilohertz to 109 megahertz, from the rotor and to the stator housing. This means effectively reduces the ratio of the stator housing to rotor core impedance divided by the rotor core to rotor shaft impedance at the high frequency. Consequently, high radio frequencies that may be coupled to the rotor core by the power switching are shunted or conducted to the stator housing rather than transmitted as EMI from the rotor shaft. The stator housing, in turn, is grounded to the chassis for the HEV.

Any of several different mechanisms may be utilized to shunt the rotor to the stator housing at the high radio frequency. In one embodiment, one or more electric brushes electrically connect the rotor shaft to the stator housing. These brushes are preferably mounted within cavities formed in the stator housing and urged into contact with the rotor shaft by compression springs.

In a still further embodiment of the present invention, an annular dielectric is positioned in between the rotor shaft and the stator housing. This dielectric is mounted to either the rotor shaft or the stator housing and is dimensioned so that an air gap is provided between the dielectric and the other of the stator housing or the rotor shaft. This dielectric effectively forms a capacitor between the stator housing and the rotor shaft. The dielectric material is selected and dimensioned such that the capacitance exhibited by the capacitor produces a low impedance at the certain radio frequency. As such, the capacitor shunts the high frequency radio emissions from the rotor core to the stator housing.

In yet another embodiment of the present invention a conductive spring ring is disposed around the rotor so that portions of the ring contact both the rotor and the stator housing. The ring thus provides the desired electrical shunt or conductive path between the rotor and the stator housing at the high frequency radio emissions thus reducing the transmission of EMI from the rotor shaft.

In still a further embodiment, electrically conductive grease may be used with the bearing assembly.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a sectional view illustrating an exemplary electric motor of the type used in an HEV;

FIG. 2 is a plan view illustrating one embodiment of the present invention;

FIG. 3 is a view similar to FIG. 2, but illustrating an embodiment installed in an electric motor;

FIG. 4 is a view similar to FIG. 3, but illustrating a modification thereof;

FIG. 5 is a sectional view illustrating yet a further embodiment of the present invention;

FIG. 6 is a cross-sectional diagrammatic view illustrating yet a further embodiment of the present invention;

FIG. 7 is a sectional view taken substantially along line 7-7 in FIG. 6 and enlarged for clarity; and

FIG. 8 is a diagrammatic view illustrating an HEV vehicle.

### DETAILED DESCRIPTION OF PREFERRED EMBODIMENTS OF THE PRESENT INVENTION

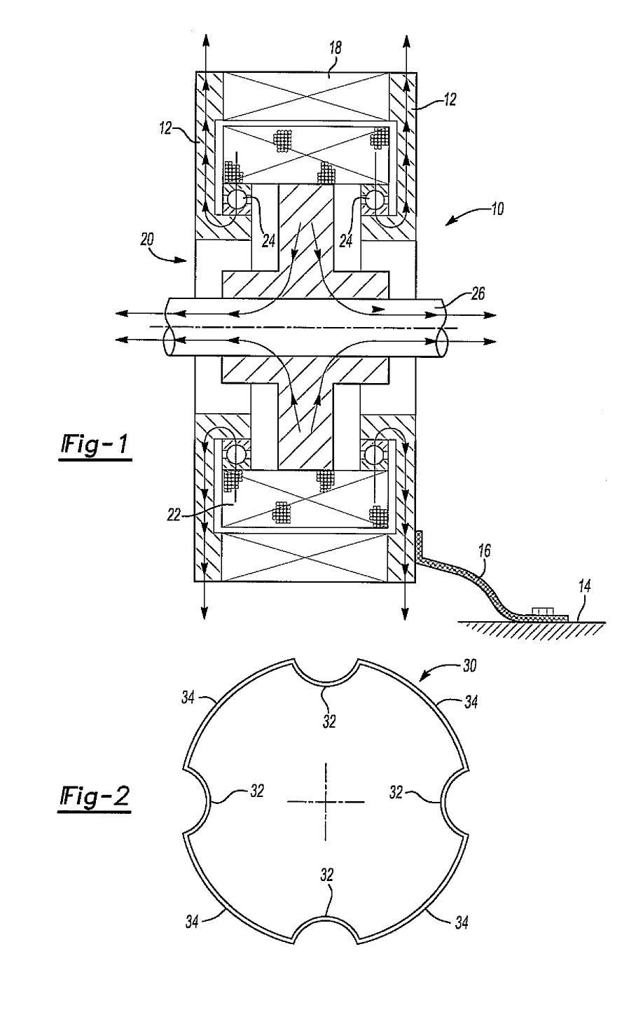

With reference first to FIG. 1, a cross-sectional view of an electric motor 10 is shown of the type used in an HEV. The motor 10 includes a stator housing 12 which is grounded to a chassis 14 of an HEV by any conventional means, such as a grounding strap 16, metal bolts and the like. The stator housing 12, furthermore, supports the stator windings 18.

A rotor 20 having a rotor core 22 is rotatably mounted to the stator housing 12 by one or more conventional bearing assemblies 24 which typically include metal bearings such as ball bearings, spindle bearings, sleeve bearings and the like. Such metal bearings 24, however, may produce relatively high impedance at high radio frequencies, i.e. radio frequencies in the range of 500 kilohertz to 110 megahertz, due to bearing lubrication and the like. Such radio frequencies overlap the AM and FM radio bands.

The rotor 20 also includes a rotor output shaft 26 which is typically metal in construction. The rotor output shaft 26 is used to drive the load, such as the drive wheels in an HEV. Since the impedance between the rotor core 22 and the rotor shaft 26 is typically very low at high radio frequencies and then is negligible. It is desirable to reduce the impedance between the rotor core 22 and the stator housing 12 to reduce the emissions of EMI from the rotor output shaft 26.

With reference now to FIGS. 2 and 3, in a first embodiment of the invention, a metallic spring ring 30 is disposed between the rotor 20 and stator housing 12. This resilient ring 30 is dimensioned so that portions 32 of the ring 30 maintain contact with the rotor 20 while other portions 34 of the ring 30 maintain contact with the stator housing 12. In practice, such a ring 30, which may be made of spring metal, presents an electrical conductive path with a very low inductance and capacitance between the rotor 20 and the stator housing 12 at high radio frequencies thus effectively reducing the impedance between the rotor core 22 and the stator housing 12 at these high radio frequencies. In doing so, the ring 30 effectively shunts the radio frequency emissions which may be present on the rotor core 22 to the stator housing 12 and ultimately to the vehicle chassis 14. Thus, the ring 30 effectively reduces the ratio of the rotor core-stator housing impedance divided by the impedance between the rotor core 22 and the rotor output shaft 26.

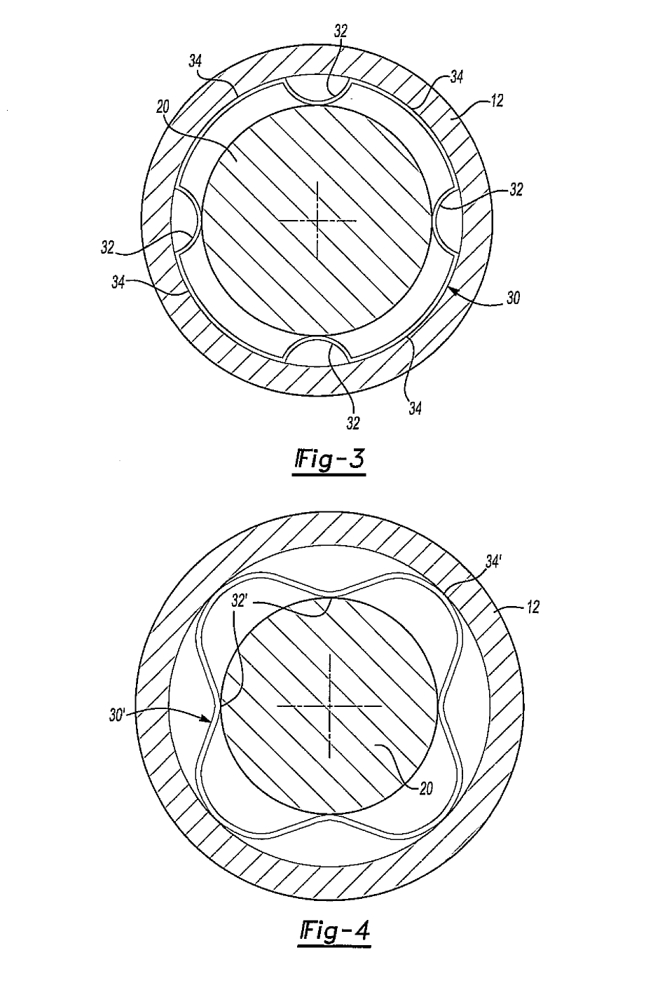

With reference now to FIG. 4, a different embodiment of the ring 30′ is illustrated having a different shape than the ring 30 illustrated in FIGS. 2 and 3. However, the ring 30′ in FIG. 4 also includes portions 32′ which maintain electrical contact with the rotor 20 as well as outer portions 34′ which maintain electrical contact with the stator housing 12. The ring 30′ is also preferably constructed of spring metal and compressed between the rotor 20 and the stator housing 12. As such, the ring 30′ illustrated in FIG. 4 illustrates in the same fashion as the ring illustrated in FIGS. 2 and 3.

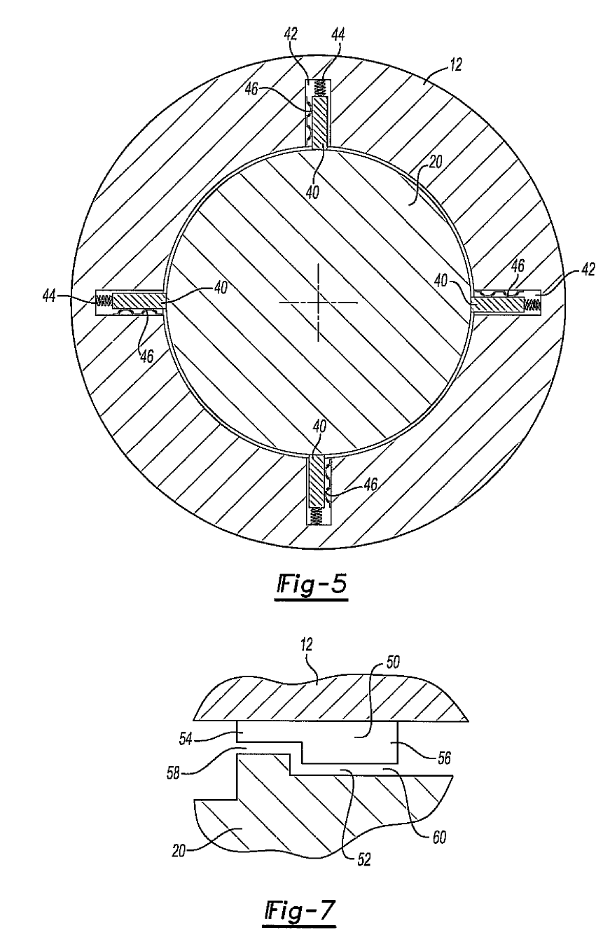

With reference now to FIG. 5, a still further embodiment of the present invention is shown in which at least one, and preferably several circumferentially spaced conductive brushes 40 are mounted within cavities 42 provided in the stator housing 12. Each cavity 42 is open to the rotor 20 while compression springs 44 are disposed between the brushes 40 and the stator housing 12 to urge the brushes 40 radially inwardly and into contact with the rotor 20. These springs 44 thus ensure electrical contact between the brushes 40 and the rotor 20 as well as a low impedance electrically conductive path between the brushes 40 and the rotor 20 at high radio frequencies.

Still referring to FIG. 5, in order to enhance the electrical contact between the brushes 40 and the stator housing 12, one or more spring clips 46 are optionally disposed in each cavity 42 so that the spring clips 46 contact one side of its associated brush 40. The spring clips 46 are preferably constructed of a spring metal material and resiliently urge the opposite side of its associated brush 40 into contact with the stator housing 12. In doing so, the spring clips 46 further reduce the impedance between the brush 40 and the stator housing 12 at high radio frequencies. Consequently, like the spring rings 30 and 30′ in FIGS. 2-4, the brushes 40 effectively reduce the impedance of the electrical path between the rotor core 22 and stator housing 12 at high radio frequencies.

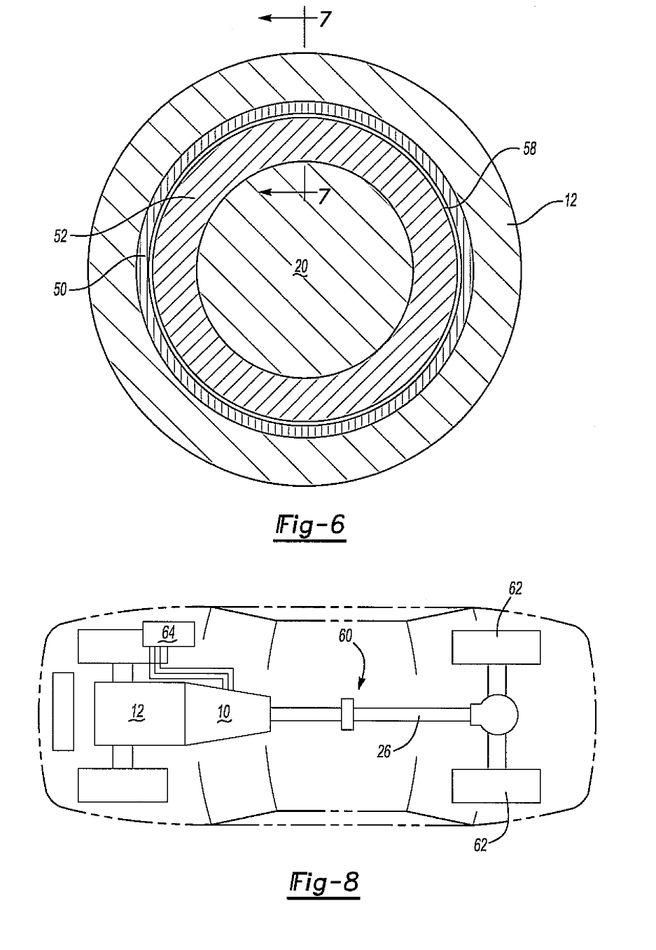

With reference now to FIGS. 6 and 7, a still further embodiment of the present invention is shown in which a dielectric layer 50 is mounted to the stator housing 12 so that the dielectric layer 50 extends annularly around the rotor 20. The dielectric layer 50, furthermore, is dimensioned so that an air gap 52 is provided between the dielectric material 50 and the rotor 12.

The dielectric material which forms the dielectric layer 50 is selected and the air gap 52 is dimensioned such that the dielectric layer together with the rotor 26 and stator housing 12 forms a bypass capacitor at high radio frequencies. As such, the bypass capacitor exhibits a very low impedance at the high radio frequencies thus effectively reducing the impedance between the rotor core and the stator housing through the bypass capacitor.

With reference now particularly to FIG. 7, in order to provide optimum performance of the bypass capacitor, the dielectric layer 50 may have two or even more different thicknesses for the dielectric layer 50, as shown at zone 54 and zone 56. Similarly, the air gap 58 between the zone 54 and the rotor 26 may be different than an air gap 60 between the thicker zone 56 of the dielectric layer 50 and the rotor 20. In this fashion, the bypass capacitor may exhibit the characteristics of two different bypass capacitors, each having a different capacitance so that the bypass capacitor formed by the dielectric layer zone 54 may provide a very low impedance electrically conductive path at one high radio frequency range, e.g. 500 kilohertz to 1.7 megahertz corresponding to the AM radio band while other bypass capacitor formed by the dielectric zone 56 may exhibit low impedance electrically conductive path at a different radio frequency range, e.g. 98 to 109 megahertz or the radio frequency of the FM radio band.

With reference now to FIG. 8, an HEV 60 is illustrated having two drive wheels 62. The motor 10 is drivingly connected to the wheels 62 by the motor output shaft 26 and powers the HEV. A power inverter 64 is carried by the HEV and electrically powers the motor 10. Thus the present invention reduces EMI transmission from the output shaft 26 by providing an electrically conductive path between the rotor and stator housing with low impedance at high radio frequencies.

From the foregoing, it can be seen that the present invention provides a novel electric motor particularly suited for an HEV in which the impedance between the rotor and the stator housing is reduced at high radio frequencies. By doing so, radio frequency emissions which may be present on the rotor windings are shunted to the stator housing rather than transmitted as EMI from the rotor shaft.

Having described our invention, however, many modifications thereto will become apparent to those of skill in the art to which it pertains without deviation from the spirit of the invention as defined by the scope of the appended claims.

We claim:

1. An electric motor comprising;
a stator housing,
a rotor rotatably mounted to said stator housing by a bearing assembly, said rotor having an output shaft,
means separate from said bearing assembly which provides an electrical conductive path for high frequency radio emissions from said rotor to said stator housing for reducing the impedance from said rotor to said stator housing and reducing the transmission of electromagnetic interference from said rotor shaft.

2. The invention as defined in claim 1 wherein said connecting means comprises an electrically conductive brush mounted in said stator housing, said brush having a portion in contact with said rotor.

3. The invention as defined in claim 2 and comprising a plurality of circumferentially spaced electrically conductive brushes mounted in said stator housing, each brush having a portion in contact with said rotor.

4. The invention as defined in claim 2 and comprising a compression spring mounted between said brush and said stator housing, said compression spring resiliently urging said brush into contact with said rotor.

5. The invention as defined in claim 2 and comprising at least one spring clip disposed between one side of said brush and said stator housing.

6. The invention as defined in claim 1 wherein said electric connecting means comprises a dielectric layer disposed between said stator housing and said rotor so that said stator housing, said dielectric layer and said rotor form a capacitor having a low impedance at said high frequency radio emissions so that said emissions are grounded from said rotor to said stator housing.

7. The invention as defined in claim 6 wherein said dielectric layer is mounted to said stator housing, said capacitor comprising an air gap between said dielectric layer and said rotor.

8. The invention as defined in claim 1 wherein said electric connecting means comprises a conductive spring clip disposed around and in contact with inner portions of said rotor, said spring clip having at least one outer portion in contact with said stator housing.

9. The invention as defined in claim 8 wherein said spring clip has circumferentially spaced portions in contact with said stator housing.

10. The invention as defined in claim 1 wherein said electric motor is used in conjunction with an electric motor automotive vehicle.

11. The invention as defined in claim 1 wherein said reducing means comprises electrically conductive lubricant embedded in said bearing assembly.

12. A method for reducing high frequency radio emissions from a rotor shaft of an electric motor having a rotor connected to the shaft, a rotor core and a stator housing, said method comprising the steps of:
rotatably mounting said rotor to said stator housing by a bearing assembly,
providing an electrical conductive path from said rotor to said stator housing separate from said bearing assembly, said conductive path reducing the impedance from the rotor to the stator housing, thereby reducing the transmission of electromagnetic interference from the shaft.

13. The invention as defined in claim 12 wherein said providing step comprises the step of providing an electrically conductive brush mounted in said stator housing such that said brush is in electrical contact with both said rotor and said stator housing.

14. The invention as defined in claim 13 and comprising the step of resiliently urging said brush radially inwardly toward said rotor.

15. The invention as defined in claim 13 and comprising a plurality of circumferentially spaced brushes disposed between said stator housing and said rotor.

16. The invention as defined in claim 12 wherein said providing step comprises the step of providing a capacitor between said stator housing and said rotor, said capacitor having a low impedance at said high frequency radio emissions.

17. The invention as defined in claim 12 wherein said providing step comprises the step of embedding an electrically conductive lubricant in the bearing assembly.

18. A system for reducing the transmission of electromagnetic interference for an electric motor vehicle comprising:
a motor having a stator housing and a rotor rotatably mounted to said stator housing by a bearing assembly, said rotor having an output shaft,
an inverter electrically connected to said motor,
an electrical conductor separate from said bearing assembly and having a low impedance at a range of high frequency radio emissions, said conductor being electrically connected between said rotor to said stator housing so that said conductor reduces the impedance from the rotor to the stator housing to thereby reduce the transmission of electromagnetic interference from said output shaft.

19. The invention as defined in claim 18 wherein said conductor comprises at least one electrically conductive brush electrically connected between said stator housing and said rotor assembly.

20. The invention as defined in claim 19 wherein said conductor comprises a plurality of circumferentially spaced electrically conductive brushes connected between said stator housing and said rotor.

21. The invention as defined in claim 19 wherein said brush is mounted in a cavity formed in said stator housing and comprising a compression spring disposed in said cavity which resiliently urges said brush radially towards said rotor.

22. The invention as defined in claim 20 and comprising a spring clip disposed in said cavity, said spring clip being compressed between one side of said cavity and one side of said brush.

23. The invention as defined in claim 18 wherein said conductor comprises a conductive spring clip disposed around and in contact with inner portions of said rotor, said spring clip having at least one outer portion in contact with said stator housing.

24. The invention as defined in claim 18 wherein said conductor comprises a capacitor.

25. The invention as defined in claim 24 wherein said capacitor comprises an annular dielectric material attached to one of said stator housing and said rotor, said dielectric material being dimensioned to form an air gap between the other of said stator housing and said rotor.
